(19) United States
(12) Patent Application Publication
(10) Pub. No.: US 2010/0219180 A1
(43) Pub. Date: Sep. 2, 2010

(54) STEAM GENERATING DEVICE

(76) Inventor: Kenichi Bamen, Saitama (JP)

Correspondence Address: SMITH PATENT OFFICE, 1901 PENNSYLVANIA AVENUE N W, SUITE 901, WASHINGTON, DC, 20006, US

(21) Appl. No.: 12/675,923

(22) PCT Filed: Jan. 28, 2008
(86) PCT No.: PCT/JP2008/051218

§ 371 Date: Mar. 1, 2010

(30) Foreign Application Priority Data
Sep. 3, 2007 (JP) 2007-228245

(51) Int. Cl. H05B 6/10

(52) U.S. Cl. 219/628

(57) ABSTRACT

The present invention provides a steam generating device having a simple structure, a miniature size and excellent durability and quietness. The steam generating device has a water storage tank (11) including a bottom wall (12) and a cylindrical side wall (13), a coil (41) wounded around an outer surface of the side wall (13) of the water storage tank (11), and a cylindrical conductive heating body (31) provided in the water storage tank (11) and induction-heated by a magnetic field that occurs by passing an alternating current through the coil (41). Further, the steam generating device heats, out of the water stored in the water storage tank (11), water between the inner surface of the water storage tank (11) and the conductive heating body (31) thereby to generate steam.

### TECHNICAL FIELD

The present invention relates to a steam generating device for generating steam that produces enhanced hot bath and beauty effects.

### BACKGROUND ART

A conventional steam generating device has a water storage tank, a heater for heating water stored in the water storage tank, ultrasonic generating means for atomizing the water stored in the water storage tank and spouting means for spouting misty water particles generated from the ultrasonic generating means. In the conventional steam generating device, water held in the water storage tank is heated directly by the heater, the ultrasonic generating means is operated to generate misty water particles, that is, steam, in the water storage tank and the misty water particles (steam) generated by the ultrasonic generating means are spouted out by the spouting means (for example, see patent documents 1 and 2).

This steam generating device is used for sauna arranged in a bath room or any hip bath. The hip bath is sauna in which the steam generating device is arranged within a sitting member such as a chair, a user sits on the sitting member and puts a sheet of high water-tightness on the head, and steam of the steam generating device is generated inside the sheet.

Patent document 1: Japanese Patent Application Laid-Open No. 2000-197682

Patent document 2: Japanese Patent Application Laid-Open No. 2002-22217

### DISCLOSURE OF THE INVENTION

### Problem to be Solved by the Invention

The steam generating device has problems that it has many parts, a complicated structure and large size and the durability is poor and service life is short. It has another problem that when the ultrasonic generating means is operated, noise occurs in association with vibration of a transducer and quietness is lost. It has yet another problem that as the generated misty water particles are large in size, excellent hot bath, therapeutic and beauty effects cannot be expected. In other words, the problem is such that as the bath user (person in a bath) is bathed in steam containing high moisture content and large molecular cluster, water particles are adhered to his entire body, its heat of vaporization cools the body and the hot bath effect is lost. In addition, there is a problem that the steam contains large water particles, they are difficult to be absorbed into the skin and the therapeutic and beauty effects are reduced.

The present invention was carried out in view of the above-mentioned problems, and has a first object to provide a steam generating device that has a simple structure and a miniature size and excellent durability and quietness. The present invention has a second object to provide a steam generating device with great hot bath, therapeutic and beauty effects by reducing in size misty water particles of the steam to be smaller than general steam water particles.

### Means for Solving the Problem

According to a first aspect of the invention, there is provided a steam generating device including: a water storage tank formed of a material having a heat resistance and non-conductivity and having an approximately circular bottom wall and an approximately cylindrical side wall formed at a circumference of the bottom wall; a coil wounded around an outer surface of the side wall of the water storage tank; and a cylindrical conductive heating body provided in the water storage tank and induction-heated by a magnetic field that occurs by passing an alternating current through the coil; wherein steam is generated by heating, out of water stored in the water storage tank, water between an inner surface of the water storage tank and the conductive heating body.

In order to attain the above-mentioned first and second objects, according to a second aspect of the invention, there is provided the steam generating device, wherein the conductive heating body is made of a carbon complex.

In order to attain the above-mentioned first and second objects, according to a third aspect of the invention, there is provided the steam generating device, wherein the conductive heating body has an upper opening, and a lid is provided to cover the upper opening and has a vent hole.

In order to attain the above-mentioned first and second objects, according to a fourth aspect of the invention, there is provided the steam generating device, wherein the lid is made of the same carbon complex as the conductive heating body.

In order to attain the above-mentioned first and second objects, according to a fifth aspect of the invention, there is provided the steam generating device, wherein the water storage tank has an upper opening and a lid member is provided to cover the upper opening of the water storage tank, the lid member is provided with an upper plate member made of the same carbon complex as the conductive heating body, and the upper plate member has a spout for spouting the steam to an outside.

### EFFECTS OF THE INVENTION

As the steam generating device of the present invention has fewer parts and a simple structure, it can be downsized. Further, as the structure is simple, it has durability and can be effectively used for a long time. Furthermore, as it does not need atomizing means such as ultrasonic generating means, it has excellent quietness. Furthermore, as the far-infrared radiation effect of the carbon complex is utilized to reduce in size the generated misty water particles, the hot bath, therapeutic and beauty effects can be enhanced.

### BRIEF DESCRIPTION OF THE DRAWINGS

FIG. 1 is a view for explaining the principle of a steam generating device according to the present invention;

FIG. 2 is a whole perspective view illustrating one embodiment of the steam generating device of the present invention;

FIG. 3 is a whole perspective view of the steam generating device of FIG. 2;

FIG. 4 is a front cross-sectional view of the steam generating device of FIG. 2;

FIG. 5 is a side cross-sectional view of the steam generating device of FIG. 2;

FIG. 6 is a plan view of the steam generating device of FIG. 2;

FIG. 7 is a cross-sectional view of substantial parts of the steam generating device of FIG. 2;

FIG. 8 is a perspective view of an upper cover part of the steam generating device of FIG. 2;

FIG. 9 is a perspective view of a lid member of the steam generating device of FIG. 2;

FIG. 10 is a perspective view of a lid cover of the steam generating device of FIG. 2; and

FIG. 11 is a perspective view of an upper plate member of the steam generating device of FIG. 2.

### BEST MODE FOR CARRYING OUT THE INVENTION

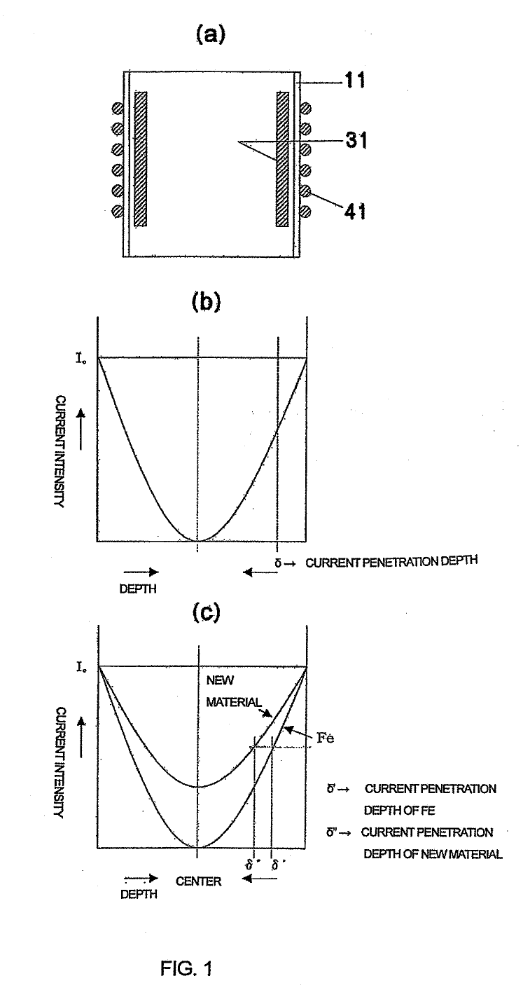

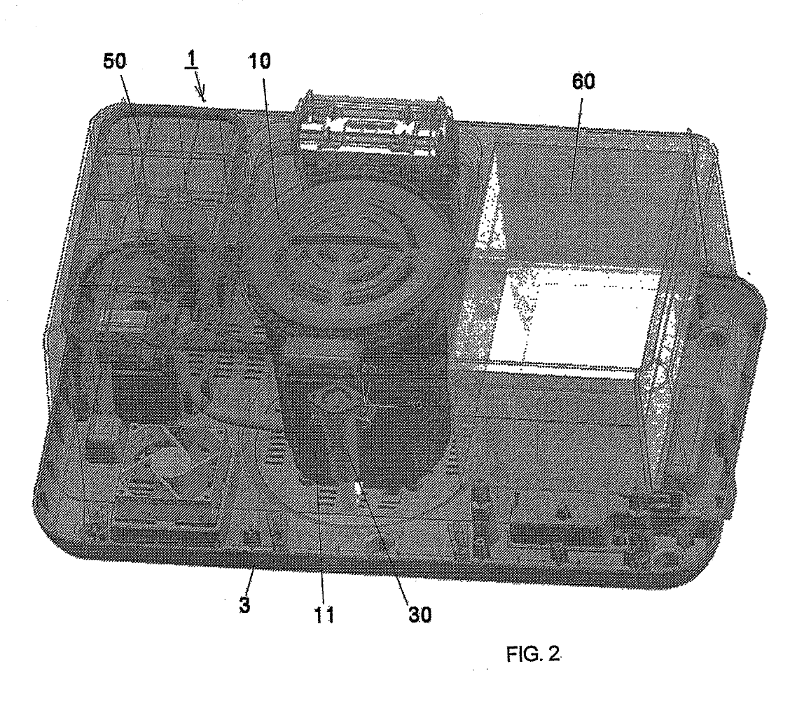

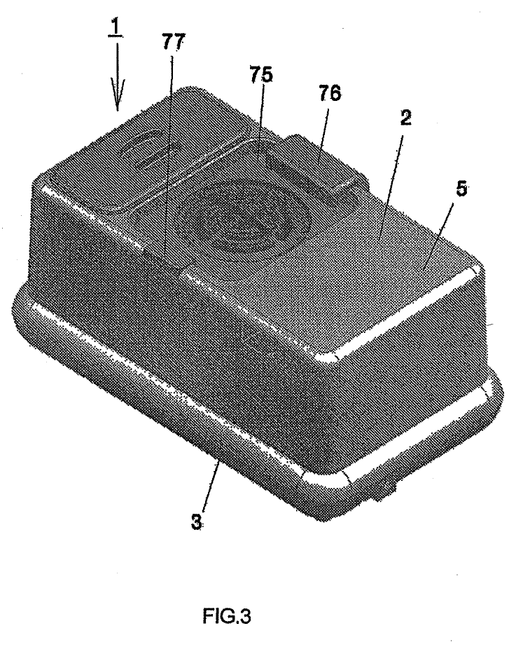

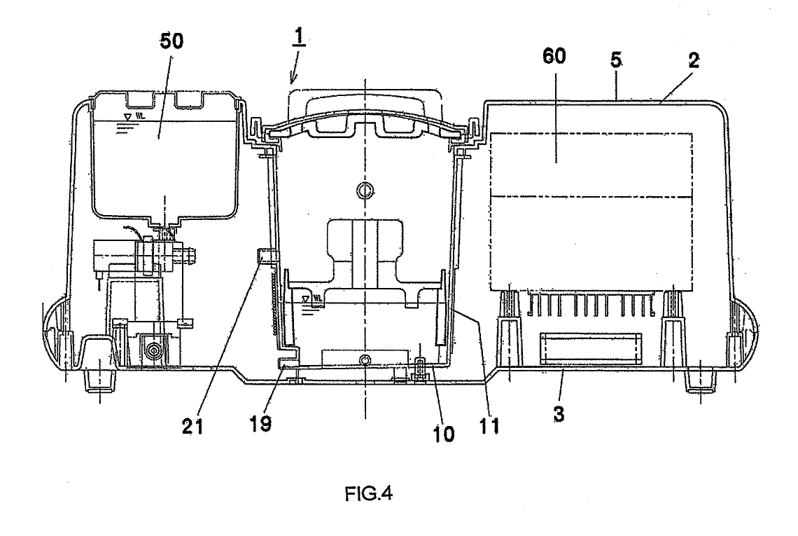

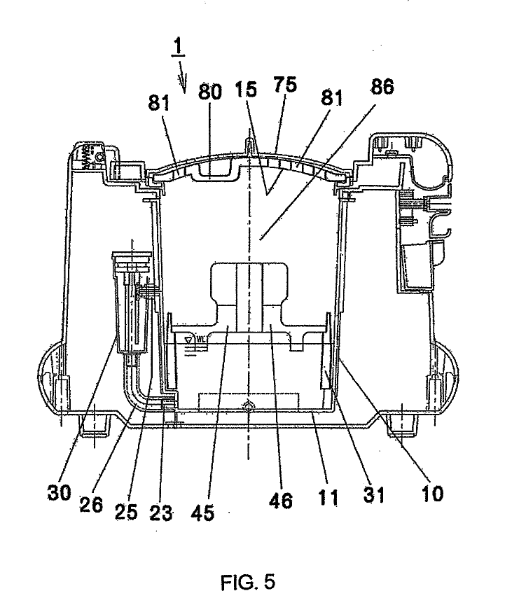

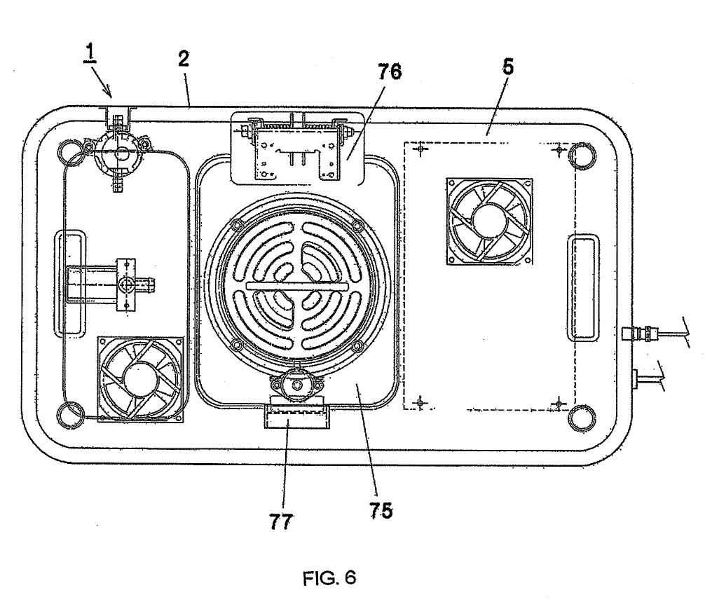

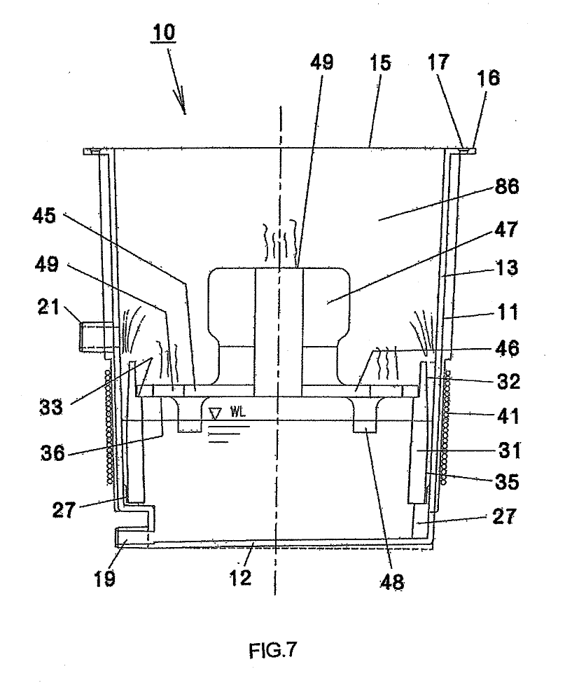

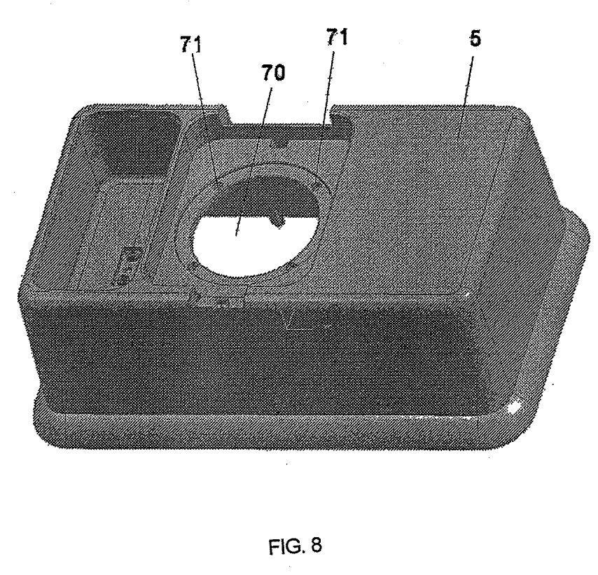

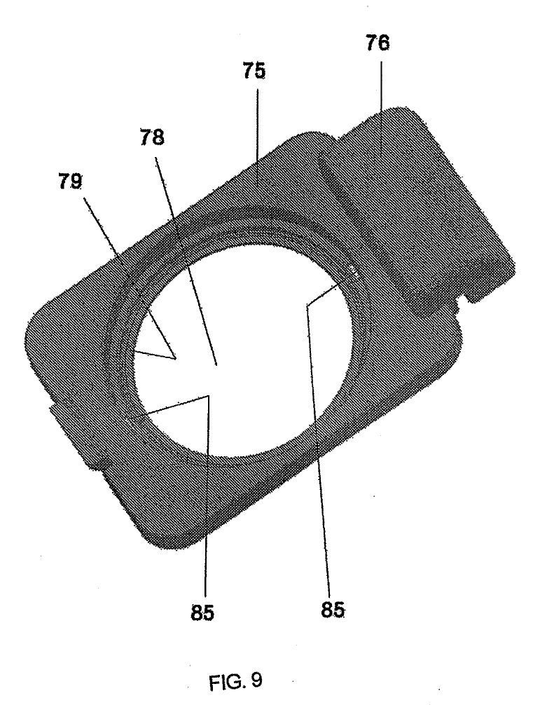

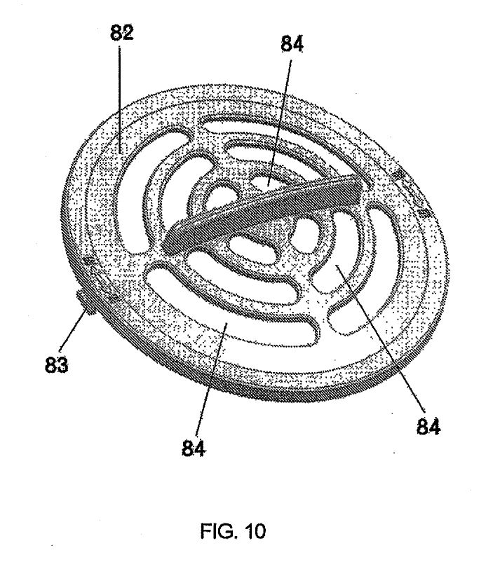

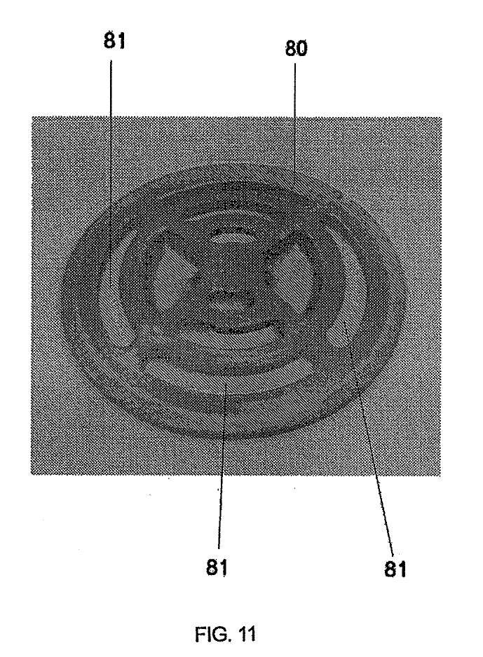

A steam generating device according to embodiments of the present invention has been explained with reference to FIGS. 1 to 11. FIG. 1 is an explanatory view of the principle of the steam generating device according to the present invention. FIG. 2 is a whole perspective view illustrating one embodiment of the steam generating device of the present invention. FIG. 3 is a whole perspective view of the steam generating device of FIG. 2. FIG. 4 is a front cross-sectional view of the steam generating device of FIG. 2. FIG. 5 is a side cross-sectional view of the steam generating device of FIG. 2. FIG. 6 is a plan view of the steam generating device of FIG. 2. FIG. 7 is a cross-sectional view of substantial parts of the steam generating device of FIG. 2. FIG. 8 is a perspective view of an upper cover part of the steam generating device of FIG. 2. FIG. 9 is a perspective view of a lid member of the steam generating device of FIG. 2. FIG. 10 is a perspective view of a lid cover of the steam generating device of FIG. 2. FIG. 11 is a perspective view of an upper plate member of the steam generating device of FIG. 2.

As illustrated in FIG. 7, the steam generating device 1 is made of a material having heat resistance and non-conductivity and includes a water storage tank 11 having an approximately circular bottom wall 12 and an approximately cylindrical side wall 13 formed on the circumference of the bottom wall 12, a coil 41 wounded around the outer surface of the side wall 13 of the water storage tank 11, and a cylindrical conductive heating body 31 provided in the water storage tank 11 and induction-heated by a magnetic field generated by passing an alternating current through the coil 41. The steam generating device 1 heats, out of water held in the water storage tank 11, water between the inner surface of the water storage tank 11 and the conductive heating body 31 thereby to generate steam.

The conductive heating body 31 is desirably made of a carbon complex. At an upper opening 36 of the conductive heating body 31, a lid 45 is provided to cover the upper opening 36 and a vent hole 49 is formed in the lid 45. The lid 45 is desirably made of the same carbon complex as the conductive heating body 31. As illustrated in FIG. 5, at an upper opening 15 of the water storage tank 11, a lid member 75 is provided to cover the upper opening 15. The lid member 75 is provided with an upper plate member 80 made of the same carbon complex as the conductive heating body 31. In the upper plate member 80, spouts 81 are provided for spouting steam to the outside.

The steam generating device 1 has a small number of parts and has a simple structure, and it can be downsized. Besides, as it has a simple structure, it has excellent durability and can be used for a long time. Further, as it does not need atomizing means such as ultrasonic generating means, it has excellent quietness. Furthermore, the size of the generated misty water particles can be reduced by far-infrared radiation effect produced by heating of the carbon complex, and the hot bath, therapeutic and beauty effects can be enhanced.

Next description is made about the basic principle of the steam generating device according to the present invention. As illustrated in FIG. 1(a), the coil 41 is wounded around the outer surface of a tubular case 11 formed of a non-conductive member such as synthetic resin, and a tubular body 31 formed of a conductive member is arranged inside the tubular case 11. A magnetic field is generated by passing an alternating current through the coil 41, which magnetic field induces an eddy current inside the tubular body 31 and its induction current heats the tubular body 31. This tubular body 31 is formed of carbon complex.

The carbon complex is manufactured as follows:

(1) Mixing maturing liquid into carbon powder in the noncrystalline form containing 10 μm to 50 μm particles, and ripening the mixture at the humidity 80%, temperature 60° C. and 1 atmospheric pressure and for about 48 hours.

(2) Molding the ripened powder in a die at the pressure of 30 MPa/cm².

(3) Firing the molded material up to 950° C.

(4) Setting the fired material in a vacuum furnace and diffusing silicon powder to give SiC.

(5) Working the surface of a material subjected to firing.

Thus, a carbon complex capable of inducing induction current is completed.

In the induction current distribution inside a typical heated body such as Fe, as illustrated in FIG. 1(b), the current intensity is reduced exponentially toward the inside and most of the whole heat value is covered by the surface layer. In order to increase heat generating efficiency, it is desirable that occurrence of induction current is distributed from the surface part of the heated body to the center part. FIG. 1(c) illustrates comparison between the carbon complex and Fe. The carbon complex has greater current penetration depth than Fe and the induction current occurs not only in the surface part but also in the center part, resulting in high heat generating efficiency. Here, the new material disclosed in FIG. 1(c) is a carbon complex.

The steam generating device is described further in detail below. As illustrated in FIG. 4, the steam generating device 1 has an apparatus main body 10 for generating steam, a water tank 50 for supplying water to the apparatus main body 10, a controller 60 for controlling the electric structure of the apparatus main body 10 and a remote controller (not shown) for controlling the controller 60.

As illustrated in FIG. 7, the apparatus main body 10 has a water storage tank 11, a coil 41 and a cylindrical conductive heating body 31. The water storage tank 11 is made of a material having heat resistance and non-conductivity, for example, a special complex material, such as PPS resin or FRP, having heat resistance up to 150° C. The water storage tank 11 has an approximately circular bottom wall 12 and an approximately cylindrical side wall 13 formed at the circumference of the bottom wall 12. The side wall 13 is inclined outward as it comes closer to the upper end opening 15, and a flange 16 is formed at the upper-end outer circumference of the side wall 13. In the flange 16, screw holes 17 are formed.

As illustrated in FIG. 7, in the side wall 13 of the water storage tank 11, a water outlet 19 is formed at a lower part thereof for discharging water from the water storage tank 11, and a water inlet 21 is formed at an upper part thereof for supplying water from the water tank 50 to the water storage tank 11. The bottom wall 12 is gradually inclined downward as it becomes closer to the water outlet 19. Besides, as illustrated in FIG. 5, the water storage tank 11 has an intake hole 23 at a lower part thereof and a discharge hole 25 at an upper part thereof. Between these intake hole 23 and discharge hole 25, a water level detector 30 is provided via a pipe 26. The water level of the water storage tank 11 is detected by the water level detector 30.

As illustrated in FIG. 7, on the bottom wall 12 of the water storage tank 11, a catch shoulder 27 is formed. On the catch shoulder 27, the conductive heating body 31 is positioned and placed. The conductive heating body 31 is cylindrically formed of a carbon complex as mentioned above and has a thickness of about 7 mm. The conductive heating body 31 has a height of about 60 mm and an inclined surface 32 at the outer circumference thereof so that the outer diameter becomes smaller from the almost half height position to the upper part. The inclination angle of the inclined surface 32 is about 2 degrees relative to the lower circumferential surface. The conductive heating body 31 has an engagement shoulder 33 at the upper inner side surface thereof for engagement with a lid 45 described later. When the conductive heating body 31 is caught in the catch shoulder 27 of the water storage tank 11, a small gap of about 1.5 mm is formed between the lower circumferential surface 35 and the inner surface of the side wall 13 of the water storage tank 11, and the upper inclined surface 32 is provided with the upper part gradually and little by little away from the inner surface of the side wall 13 of the water storage tank 11

The conductive heating body 31 has an almost half height of the water storage tank 11. The coil 41 is wound around an outer circumferential surface of the side wall 13 of the water storage tank 11, facing the conductive heating body 31. At the engagement shoulder 33 of the conductive heating body 31, the circumferential edge of the lid 45 is engaged therewith so as to cover the upper opening 36 of the conductive heating body 31. The lid 45 has a disc part 46, a grip part 47 and a guide protrusion 48, which are made of the same carbon complex as the conductive heating body 31. In the center of the grip part 47 and the disc part 46, a vent hole 49 is formed for letting the steam out.

The apparatus main body 10 is attached to the case 2 as illustrated in FIG. 4. The case 2 has a lower case 3 and an upper case 5, which are secured with a screw into one piece. The apparatus main body 10 is arranged approximately in the center of the lowercase 3 and screwed to be fixed. At the both sides of the case 2 sandwiching the apparatus main body 10, the water tank 50 and the controller 60 are provided.

A water supply pipe connected between the water inlet 21 of the water storage tank 11 and the water tank 50 has a water supply pump for supplying water in the water tank 50 into the water storage tank 11 forcibly and a water supply electromagnetic valve for starting and stopping water supply. In addition, the water discharge pipe connected to the water outlet 19 has a water discharge pump for discharging water inside the water storage tank 11 forcibly and a water discharge electromagnetic valve for starting and stopping water discharge.

The controller 60 is controlled by the remote controller (not shown). When the water level detector 30 detects a water level that shows shortage of the water, the controller 60 starts driving of the water supply pump and opens the water filling electromagnetic valve to supply the water inside the water tank 50 into the water storage tank 11. When the water level detector 30 detects a water level that shows sufficient storage of the water, the controller 60 stops driving of the water supply pump and closes the water filling electromagnetic valve to stop water supply into the water storage tank 11.

As illustrated in FIG. 8, the upper case 5 has an opening 70 of outer diameter equal to that of the upper opening 15 of the water storage tank 11. At the circumference of the opening 70, a through hole 71 is formed facing the screw hole 17 of the water storage tank 11. A screw is inserted into the through hole 71 and fit in the screw hole 17 so that the upper part of the water storage tank 11 is fixed to the upper case 5. One end of the lid member 75 for blocking the upper opening 15 of the water storage tank 11 is attached to the upper case 5 pivotally via a hinge 76. The other of the lid member 75 is locked by the lock means 77 provided in the upper case 5.

As illustrated in FIG. 9, the lid member 75 has a circular hole 78 of outer diameter equal to that of the upper opening 15 of the water storage tank 11. At the periphery of the circular hole 78, an engagement edge 79 is formed, with which a circular disc shaped upper plate member 80 is engaged as illustrated in FIG. 1. In the upper plate member 80, a plurality of spouts 81 is formed for spouting steam to the outside. The upper plate member 80 is made of the same carbon complex as the conductive heating body 31. A lid cover 82 is attached to the lid member 75 for fixing the upper plate member 80 engaged at the engagement edge 79 of the circular hole 78. The lid cover 82 has a vent hole 84, an engagement claw 83 is formed at the circumference thereof, the engagement claw 83 is engaged with an engagement hole 85 formed at the periphery of the circular hole 78 of the lid member 75 to be mounted on the lid member 75 and the upper plate member 80 is pushed downward to be fixed. Here, the lid cover 82 may be also made of carbon complex.

As water inside the water storage tank 11 is supplied automatically, the steam generating device 1 can be used continuously and anyone can use the apparatus easily without checking the water inside the water storage tank 11. The controller 60 can control heating of the conductive heating body 31 by passing an alternating current through operation a remote controller (not shown).

The steam generating device 1 has the above-mentioned structure and is used as follows. A lock of locking means 77 is released to open the lid member 75 so that the upper end opening 15 of the water storage tank 11 is opened. Next, the lid 45 is removed and herb (not shown) is put in the tubular conductive heating body 31. The herb is drug plant, sweet herb or the like and held in a bag such as net or cloth bag. The lid 45 is engaged with the engagement shoulder 33 of the conductive heating body 31 to block the upper opening 36 of the conductive heating body 31 and the lid member 75 is closed to lock the locking means 77.

When the remote controller is operated, the controller 60 opens the water supply electromagnetic valve to start the water supply pump. Then, water inside the water tank 50 is supplied to the water storage tank 11 and automatically stored in the water storage tank 11. When the water level detector 30 is used to detect completion of supply of a predetermined amount of water in the water storage tank 11, the controller 60 closes the water supply electromagnetic valve and stops the operation of the water supply pump. Water is supplied to such an extent that the water does not reach the disc part 46 of the lid 45. Once the water is stored inside the water storage tank 11, the above-mentioned herb sinks in the water and herb nutrient elements are melted into the water. Here, the bag with herb stored therein is pushed down by a guide projection 48 in order to prevent the bag from floating out and blocking the vent hole of the lid 45.

In addition, when the remote controller is operated, the controller 60 makes an alternating current pass through the coil 41 to generate a magnetic field around the coil 41 and induce eddy current inside the conductive heating body 31, which induced current heats the conductive heating body 31. As described above, the conductive heating body 31 is made of a carbon complex, it is heated efficiently. It is heated to such a degree that water in a small gap between the inner surface of the water storage tank 11 and the circumferential surface of the conductive heating body 31 comes to a boil and then, steam with nutrient herb elements melt therein is generated much. The steam flows into a space 86 between the lid member 75 and the lid 45 of the water storage tank 11 and is blown out through the vent hole 84 of the lid cover 82 and spouts 81 of the upper plate member 80 provided at the lid member 75. The temperature of the steam is about 78° C. Besides, the water inside the conductive heating body 31 is heated, its steam passes through the vent hole 49, flows into the space 86 between the lid member 75 and the lid 45 in the water storage tank 11 and flows out via the spouts 81 of the upper plate member 80 provided at the lid member 75.

As described above, the lid 45 and the upper plate member 80 are made of the same material, carbon complex, as the conductive heating body 35, they are heated by the influence of the magnetic field generated by the coil 41. Thus, the conductive heating body 31, the lid 45 and the upper plate member 80 emit far-infrared radiation, miniaturize water molecular cluster of the water inside the water storage tank 11, generate negative ions, and effectively operate in absorption of deodorization, bacteria-proof, electromagnetic wave and the like. If the lid ember 75 is also made of carbon complex, the effects can be improved further.

In the steam generating device 1, as water particles contained in the steam are miniaturized by the far-infrared radiation, they can be easily absorbed into the skin, thereby enhancing beauty effect. Further, as the person in a bath receives the steam of small water particles, there is less possibility that the evaporation heat of the water particles cools his body, thereby being able to hold the hot bath effect. Thus, as the steam generating device 1 gives enhanced hot bath and beauty effects, it can generate steam suitable for sauna and hip bath. Further, the upper plate member 80 made of carbon complex is provided in the vicinity of the human body, which can be acted upon by the far-infrared radiation effectively.

Here, if in the steam generating device 1, herb is arranged in the water storage tank 11, herb ingredients are melted into the water held in the water storage tank 11. Then, the aromatic effect of the herb inside the steam can get rid of stress of a person in the bath, relax his mind and give him a fresh feeling. Besides, as the water particles are in a water molecule cluster which is miniaturized by the far-infrared radiation and is easily absorbed into the skin, the nutrient elements of herb is impregnated into the skin, thereby further enhancing the therapeutic and beauty effects.

The steam generating device 1 can generate a larger amount of steam for a short time at lower power consumption as compared with a conventional heater-type steam generating device. Further, as in the heater-type steam generating device, a heater is placed inside the water and water is directly heated thereby, the surface of the heater needs to be coated with special coating or the like for corrosion proof of the heater, and this maintenance of the heater is very cumbersome. On the other hand, as the steam generating device 1 does not need any heater, it can be maintained easily and there is no concern of electric leak and accident. Further, as compared with the conventional heater-type steam generating device that needs an ultrasonic generating means to generate the steam, the steam generating device 1 does not need any ultrasonic generating means and therefore, it can be reduced in weight, structured simply and compactly, and can be given quietness due to elimination of the vibration sound of the ultrasonic generating means.

Further, in the steam generating device 1, as the lid member 75 is opened, the upper end opening 15 of the water storage tank 11 is opened and the lid 45 and the conductive heating body 31 can be taken out, the inside of the water storage tank 11, the lid 45 and the conductive heating body 31 can be easily cleaned up. Thus, as compared with the conventional heater-type steam generating device, the steam generating device 1 has a simpler structure, is easy to manufacture and carry, is excellent in safety and durability and can be easily maintained.

In the steam generating device 1, the conductive heating body 31 is made of a carbon complex, which gives the following advantages as compared with a conductive heating body made of iron.

(1) The weight can be reduced to about 1/2.7 times the iron.

(2) The time of generating steam is about 4.5 minutes for the carbon complex and 9.5 minutes for the iron. The speed of generating steam for the case of carbon complex can be about twice as high as the case of iron.

(3) The average steam temperature is 52° C. for the iron and 78° C. for the carbon complex. The amount of generated steam is increased dramatically.

(4) The carbon complex is rustproof and excellent in durability, while for the iron, coating is easy peeled and the iron rusts easily.

Thus, in the steam generating device 1, though the conductive heating body 31 can be made of metal such as iron, as it is made of carbon complex, the steam generating device 1 is advantageous in the above-mentioned points and also it produces the far-infrared radiation effect. Hence, the conductive heating body 31 is desirably made of a carbon complex.

### INDUSTRIAL APPLICABILITY

The steam generating device according to the present invention is placed in a bath room and usable in sauna, or so-called hip bath.

### EXPLANATION OF REFERENCE NUMERALS

1 steam generating device
2 case
3 lower case
5 upper case
10 apparatus main body
11 water storage tank (tubular case)
12 bottom wall
13 side wall
15 upper end opening
16 flange
17 screw hole
19 water outlet
21 water inlet
23 intake hole
25 discharge hole
26 pipe
27 catch shoulder
30 water level detector
31 conductive heating body (tubular body)
32 inclined surface
33 engagement shoulder
35 lower circumferential surface
36 upper opening
41 coil
45 lid
46 disc part
47 grip part
48 guide protrusion
49 vent hole
50 water tank
60 controller
70 opening
71 through hole
75 lid member
76 hinge
77 locking means
78 circular hole
79 engagement edge
80 upper plate member
81 spout
82 lid cover
83 engagement claw
84 vent hole
85 engagement hole
86 space

1. A steam generating device comprising:
a water storage tank formed of a material having a heat resistance and non-conductivity and having an approximately circular bottom wall and an approximately cylindrical side wall formed at a circumference of the bottom wall;
a coil wounded around an outer surface of the side wall of the water storage tank; and
a cylindrical conductive heating body provided in the water storage tank and induction-heated by a magnetic field that occurs by passing an alternating current through the coil;
wherein steam is generated by heating, out of water stored in the water storage tank, water between an inner surface of the water storage tank and the conductive heating body.

2. The steam generating device according to claim 1, wherein the conductive heating body is made of a carbon complex.

3. The steam generating device according to claim 1, wherein the conductive heating body has an upper opening, and a lid is provided to cover the upper opening and has a vent hole.

4. The steam generating device according to claim 2, wherein the conductive heating body has an upper opening, and a lid is provided to cover the upper opening and has a vent hole.

5. The steam generating device according to claim 3, wherein
the lid is made of the same carbon complex as the conductive heating body.

6. The steam generating device according to claim 4, wherein the lid is made of the same carbon complex as the conductive heating body.

7. The steam generating device according to claim 2, wherein the water storage tank has an upper opening and a lid member is provided to cover the upper opening of the water storage tank,
the lid member is provided with an upper plate member made of the same carbon complex as the conductive heating body, and
the upper plate member has a spout for spouting the steam to an outside.

8. The steam generating device according to claim 3, wherein the water storage tank has an upper opening and a lid member is provided to cover the upper opening of the water storage tank,
the lid member is provided with an upper plate member made of the same carbon complex as the conductive heating body, and
the upper plate member has a spout for spouting the steam to an outside.

9. The steam generating device according to claim 4, wherein the water storage tank has an upper opening and a lid member is provided to cover the upper opening of the water storage tank,
the lid member is provided with an upper plate member made of the same carbon complex as the conductive heating body, and
the upper plate member has a spout for spouting the steam to an outside.

10. The steam generating device according to claim 5, wherein the water storage tank has an upper opening and a lid member is provided to cover the upper opening of the water storage tank,
the lid member is provided with an upper plate member made of the same carbon complex as the conductive heating body, and
the upper plate member has a spout for spouting the steam to an outside.

11. The steam generating device according to claim 6, wherein the water storage tank has an upper opening and a lid member is provided to cover the upper opening of the water storage tank,
the lid member is provided with an upper plate member made of the same carbon complex as the conductive heating body, and
the upper plate member has a spout for spouting the steam to an outside.
